(19) United States
(12) Patent Application Publication
(10) Pub. No.: US 2002/0113938 A1
(43) Pub. Date: Aug. 22, 2002

(54) Free-space optical cross-connect

(76) Inventors: Alexander D. Galpern, St. Petersbourg (RU); Robert G. Lindquist, Elmira, NY (US); Rui-Qing Ma, Painted Post, NY (US); Vitaly I. Sukhanov, St. Petersbourg (RU)

Correspondence Address: CORNING INCORPORATED, SP-TI-3-1, CORNING, NY, 14831

(21) Appl. No.: 09/991,403

(22) Filed: Nov. 20, 2001

(30) Foreign Application Priority Data
Nov. 20, 2000 (RU) 2000128959

(51) Int. Cl. G02F 1/13

(52) U.S. Cl. 349/202

(57) ABSTRACT

The present invention discloses an optical cross-connection device. The device is fabricated by disposing liquid crystal polarization modulators on a polarization beam splitting cube. The modulators effect switching by changing the polarization state of the light signal passing through the liquid crystal cell. The beam splitting cube directs the signal according to the polarization state. Several prisms are also disposed on the cube. The prisms are used to direct the light signals inside the switch. The device is simple to make, relatively inexpensive, and compact. Because it uses standard LCD technology there are very few mechanical parts subject to fatigue and other reliability issues.

### BACKGROUND OF THE INVENTION

1. Field of the Invention

The present invention relates generally to optical switches, and particularly to free-space liquid crystal optical cross-connects.

2. Technical Background

Liquid crystal devices are well known and can be found in numerous applications. The most prevalent use of TN/STN devices is in the area of displays; however, these devices have been proposed for optical communications applications.

Twisted nematic liquid crystal cells include alignment layers that cause the liquid crystal molecules to form a 90° helix. The helix functions as a waveguide. When no voltage is applied a polarized light signal is rotated by approximately 90° by adiabatic following. When power is applied to the cell, the helical alignment of the liquid crystal molecules is disrupted and the polarized light signal passes through the cell without being rotated. The polarization rotational capabilities of liquid crystal devices can be used as the basis for an optical switch.

Currently, telecommunications designers are experiencing an intense competition to produce a reliable, small-scale (less than 16×16) non-blocking optical cross-connect. What is needed is a simple, low cost, compact, non-mechanical solution for small-scale optical switches.

### SUMMARY OF THE INVENTION

Accordingly, the present invention discloses an optical switching device that cross-connects light signals received from a plurality of input ports into a plurality of output ports. The device is simple to make, relatively inexpensive, and compact. Because it uses standard LCD technology there are very few mechanical parts subject to fatigue and other reliability issues.

One aspect of the present invention is an optical device for directing a plurality of light signals, the plurality of light signals being received from a plurality of input ports and cross-connected into a plurality of output ports. The optical device includes a plurality of polarization modulators coupled to the plurality of input ports and the plurality of output ports, wherein each polarization modulator is selectable to modulate one of the plurality light signals between a first polarization state and a second polarization state. A light routing device is coupled to and interposed between the plurality of polarization modulators, the light routing device reflecting light signals in the first polarization state and transmitting light signals in the second polarization state. A plurality of prisms are coupled to the light routing device, whereby a light signal within the optical device is re-directed to a selected output.

In another aspect, the present invention includes a modular free-space optical switch for directing a plurality of light signals. The optical switch includes at least one first optical switch component for cross-connecting the plurality of light signals. The first optical switch component includes a plurality of first inputs and a plurality of first outputs. A polarization beam splitter is included that has a cubic shape, and is coupled to the plurality of first inputs and the plurality of second outputs, whereby light signals having a first polarization state are reflected and light signals having a second polarization state are transmitted. A plurality of liquid crystal modulators are coupled to the polarization beam splitter, each liquid crystal modulator being selectable to modulate one of the plurality light signals between a first polarization state and a second polarization state, and a plurality of prisms are coupled to the polarization beam splitter and the plurality of liquid crystal modulators, whereby the plurality of light signals propagating within the optical device are re-directed. The optical switch also includes at least one second optical switch component for cross-connecting the plurality of light signals. The second optical switch component is the mirror image of the first optical switch component, rotated 90° with respect the first optical switch component. It has a plurality of second inputs and a plurality of second outputs, whereby the second inputs are aligned and coupled to the first outputs.

In another aspect, the present invention includes a method for fabricating an optical cross-connect. The method includes the steps of providing a polarization beam splitting cube. A plurality of liquid crystal modulators are disposed on the polarization beam splitting cube. A plurality of prisms are disposed on the polarization beam splitting cube.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description are merely exemplary of the invention, and are intended to provide an overview or framework for understanding the nature and character of the invention as it is claimed. The accompanying drawings are included to provide a further understanding of the invention, and are incorporated in and constitute a part of this specification. The drawings illustrate various embodiments of the invention, and together with the description serve to explain the principles and operation of the invention.

### BRIEF DESCRIPTION OF THE DRAWINGS

FIG. 1 is a perspective view of the optical switch according to a first embodiment of the present invention;

FIGS. 2A-2D are diagrammatic depictions of the signal flows through the optical switch shown in FIG. 1;

FIG. 3 is a diagrammatic depiction of the quadrapartite space created by the prisms used in the optical switch shown in FIG. 1;

FIGS. 4A-4D are diagrammatic depictions of the signal flow through the quadrapartite space shown in FIG. 3;

FIG. 5 is a perspective view of the optical switch according to a second embodiment of the present invention;

FIG. 6 is schematic illustrating the optical configuration of the switch shown in FIG. 5; and

FIG. 7 is a perspective view of the optical switch according to a second embodiment of the present invention.

### DETAILED DESCRIPTION OF THE INVENTION

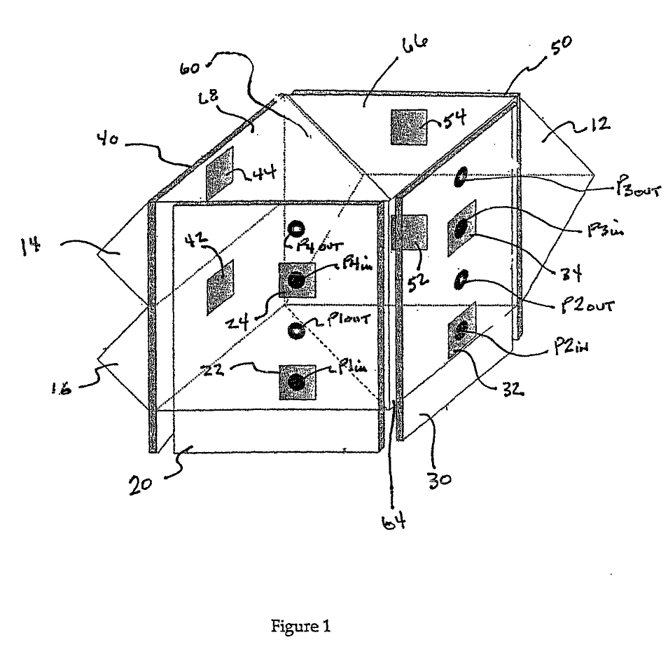

Reference will now be made in detail to the present preferred embodiments of the invention, examples of which are illustrated in the accompanying drawings. Wherever possible, the same reference numbers will be used throughout the drawings to refer to the same or like parts. An exemplary embodiment of the optical switch of the present invention is shown in FIG. 1, and is designated generally throughout by reference numeral 10.

In accordance with the invention, the present invention for an optical switch includes a plurality of liquid crystal polarization modulators that are selectable to modulate light signals between an s-polarization state and a p-polarization state. The liquid crystal polarization modulators are mounted on a polarization beam splitting cube. The beam splitting cube is a light routing device that reflects light signals in the s-polarization state and transmits light signals in the p-polarization state. A plurality of prisms are also mounted on the beam splitting cube to re-direct a light signal into a selected output. Thus, the optical switch cross-connects light signals received from a plurality of input ports into a plurality of output ports. The switch is simple to make, relatively inexpensive, and compact. Because it uses standard LCD technology there are very few mechanical parts subject to fatigue. Thus, the optical switch is very reliable.

As embodied herein, and depicted in FIG. 1, a perspective view of the optical switch 10 according to a first embodiment of the present invention is disclosed. At the center of optical switch 10 is polarized light router 60. Polarized light router 60 includes facets 62, 64, 66, and 68, respectively. Polarization modulator 20 is mounted on facet 62. Polarization modulator 20 includes two independently controlled pixels, 22 and 24, respectively. Pixel 22 is coincident to input port P1ᵢₙ, and pixel 24 is coincident to input port P4ᵢₙ. Output ports P1ₒᵤₜ and P4ₒᵤₜ are also disposed on polarization modulator 20. Polarization modulator 30 is mounted on facet 64. Polarization modulator 30 includes two independently controlled pixels, 32 and 34, respectively. Pixel 32 is coincident to input port P2ᵢₙ and pixel 34 is coincident to input port P3ᵢₙ. Output ports P2ₒᵤₜ and P3ₒᵤₜ are also disposed on polarization modulator 30. Polarization modulator 50 is mounted on facet 66. Polarization modulator 50 includes two independently controlled pixels, 52 and 54, respectively. Prism 12 is mounted on polarization modulator 50. Polarization modulator 40 is mounted on facet 58. Polarization modulator 40 includes two independently controlled pixels, 42 and 44, respectively. Prism 14 is mounted on an upper portion of polarization modulator 40, and prism 16 is mounted on a lower portion of polarization modulator 40.

It will be apparent to those of ordinary skill in the pertinent art that modifications and variations can be made to polarized light router 50 of the present invention depending on the compactness of the design. For example, polarized light router 50 may be of any suitable type, but there is shown by way of example a polarization beam splitting cube that is very compact and allows other elements to be mounted thereon with relative ease. Beam splitting cube 50 reflects s-polarized light and transmits p-polarized light. It will also be apparent to those of ordinary skill in the pertinent art that modifications and variations can be made to polarization modulators 20, 30, 40 and 50, as well. For example, polarization modulators 20, 30, 40, and 50 can be implemented using twisted nematic liquid crystal devices as well as ferroelectric liquid crystal devices.

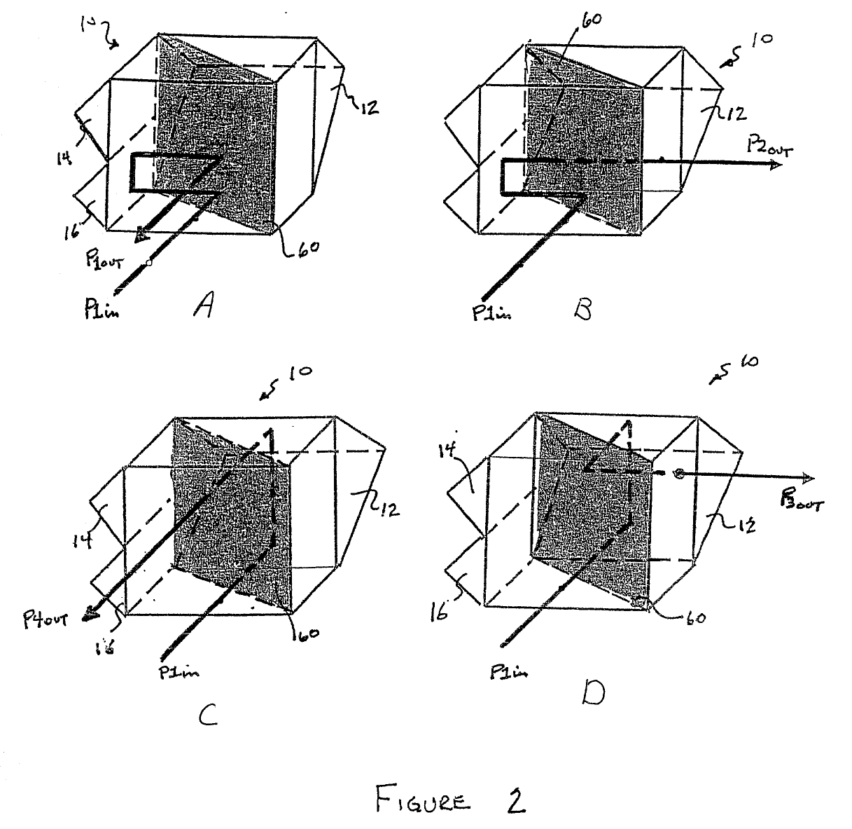

As embodied herein, and depicted in FIGS. 2A-2D, examples of the signal flow through the optical switch shown in FIG. 1 are disclosed. The examples in these Figures illustrate the operation of beam splitter 60 and prisms 12, 14, and 16. In the first example shown in FIG. 2A, an s-polarized beam enters the switch via input port P1ᵢₙ. Beam splitter 60 reflects the s-polarized light signal to prism 16. Prism 16 reflects the signal upward and back to beam splitter 60. Beam splitter 60 directs the s-polarized light signal out of switch 10 via output port P1ₒᵤₜ. In FIG. 2B, an s-polarized light signal is directed into switch 10 via input port P1ᵢₙ. The signal is reflected by prism 16 and converted to a p-polarized light signal by pixel 42 (not shown). Since beam splitter 60 transmits p-polarized light, the signal passes through beam splitter 60 and out of switch 10 via output port P2ₒᵤₜ. In FIG. 2C, a p-polarized light signal enters switch 10 by input port P1ᵢₙ. The signal passes through beam splitter 60 and reflected upward and outward by prism 12. The signal passes through beam splitter 60 and out of switch 10 by port P4ₒᵤₜ. In the fourth example shown in FIG. 2D, a p-polarized light signal enters switch 10 by input port P1ᵢₙ. The signal passes through beam splitter 60 and reflected upward and outward by prism 12. The signal's polarity is switched by either pixel 52 or pixel 54 (neither is shown in the Figure) and the s-polarized signal is reflected by beam splitter 60 out of switch 10 via output port P3ₒᵤₜ. One of ordinary skill in the art will recognize that prisms 12, 14, and 16 create a quadripartite switching space when used in conjunction with liquid crystal modulators 20, 30, 40, and 50, and beam splitter 60.

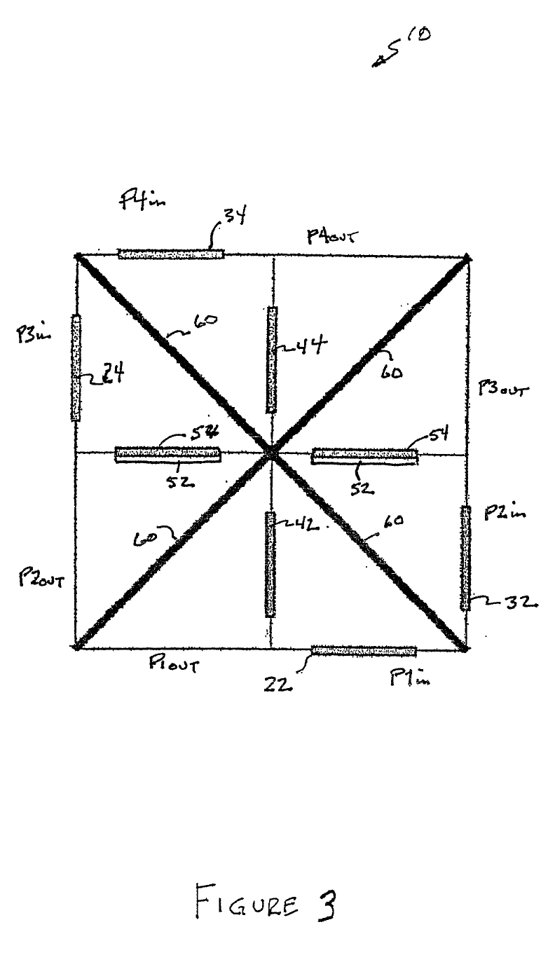

As embodied herein, and depicted in FIG. 3, a diagrammatic depiction of the quadrapartite switching space created by prisms 12, 14, and 16 is disclosed. The switching space includes four quadrants, Q1, Q2, Q3, and Q4. Each quadrant is bisected by beam splitter 60. Quadrants Q1 and Q3 are input quadrants. Quadrants Q2 and Q4 are output quadrants. Each quadrant contains interior pixels 52 and 54, which form a pair because of there positional relationship to prism 12. Quadrant 1 includes input pixels 22 and 32, in addition to interior pixel 42. Quadrant Q2 shares interior pixel 42. Quadrant Q3 includes input pixels 24 and 34, and interior pixel 44. Quadrant Q4 shares interior pixel 44 with quadrant Q3. A close comparison of FIGS. 1 and 3 shows that quadrants 1 and 2 represent the first and second I/O port pair (P1ᵢₙ, P1ₒᵤₜ , P2ᵢₙ, P2ₒᵤₜ), whereas quadrants 3 and 4 represent the third and fourth I/O pair (P3ᵢₙ, P3ₒᵤₜ, P4ᵢₙ, P4ₒᵤₜ).

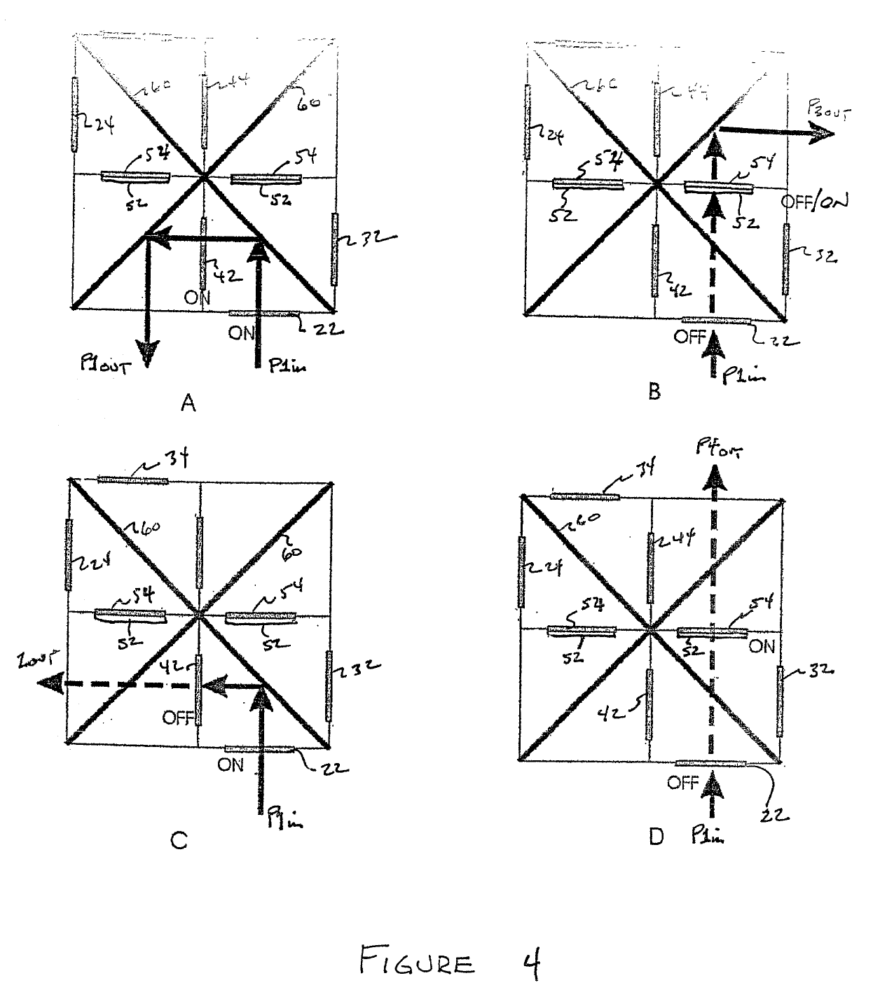

As embodied herein, and depicted in FIG. 4A-4D diagrammatic depictions of the signal flows (shown in FIG. 2) through the quadrapartite space shown in FIG. 3 are disclosed. FIG. 4A shows the signal path through the quadrapartite space from P1ᵢₙ to P1ₒᵤₜ. The s-polarized signal passes through pixel 22 which is in the on-state. Thus, the polarization state of the signal is unchanged and the signal is reflected by beam splitter 60 to interior pixel 42 which is alos turned on. The signal is then reflected by beam splitter 60 into P1ₒᵤₜ. In FIG. 4B, an s-polarized signal is converted by pixel 22 (off-state) into a p-polarized signal. The p-polarized signal is transmitted by beam splitter 60 to pixel 52. Referring back to FIG. 1, pixel 52 is disposed on the lower portion of prism 12, and pixel 54 is disposed on the upper portion of prism 12. Thus, in the quadrapartite space shown in FIGS. 3 and 4, pixels 52 and 54 appear to situated back-to-back from one another. In the example shown in FIG. 4B, one pixel in the pair must be on and the other must be off to change the polarization state from the p-polarization state to the s-polarization state. After passing through pixel pair 52 and 54, the s-polarized light signal is reflected by beam splitter 60 into P3ₒᵤₜ. FIG. 4C shows the signal being routed from P1ᵢₙ to P2ₒᵤₜ. The s-polarized light signal is transmitted through pixel 22 (on-state) and is reflected by beam splitter 60 to pixel 42 (off-state), which converts the signal into a p-polarized signal. The p-polarized signal is transmitted through beam splitter 60 into port P2ₒᵤₜ . In the last example, pixel 22 is in the off-state, converting the s-polarized signal into a p-polarized signal which passes through pixel pair 52 and 54, both in the on-state. The p-polarized signal passes through beam splitter 60 into port P4ₒᵤₜ.

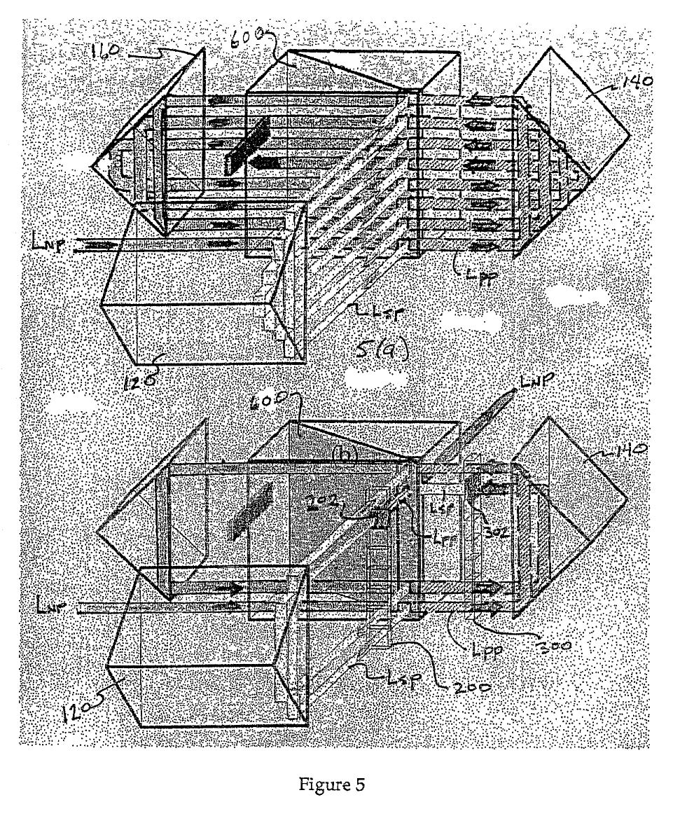

In a second embodiment of the invention, as embodied herein and as shown in FIG. 5(a) and FIG. 5(b) a perspective view of the optical switch according to a second embodiment of the present invention is disclosed. In FIG. 5(a) switch 100 includes beam splitter 600, and prisms 120, 140, and 160. Prism 160 is smaller than prisms 120 and 140 to accommodate N-input ports, N being an integer. M-output ports are disposed on the facet of beam splitter cube 600 that does not accommodate a prism. FIG. 5(a) illustrates the operation of beam splitter 600 and prisms 120, 140, and 160. An unpolarized light signal is directed into the device and split into an s-polarized component and a p-polarized component by beam splitter 600. The components are directed back toward beam splitter 600 by prisms 120 and 140 where they are recombined.

In FIG. 5(b), liquid crystal modulator 200 is disposed between beam splitter 600 and prism 120. Liquid crystal modulator 300 is disposed between beam splitter 600 and prism 140. Once again, a pixel in the off-stae will rotate the polarization state by 90°, whereas the pixel in the on-state will not rotate the polarization state. FIG. 5(b) illustrates the operation of liquid crystal modulators 200 and 300. Non-polarized light signal Lnp is directed into the input port and split into its constituent polarization components Lsp (s-polarized) and Lpp (p-polarized), respectively. Pixel 202 (off-state) converts the received Lsp signal into an Lpp signal which passes through beam splitter 600. Pixel 302 (off-state) converts the Lpp signal into the Lsp signal. The Lsp signal and the Lpp signal are recombined by beam splitter 600 and directed into the output port disposed on the beam splitter cube facet that does not accommodate a prism member.

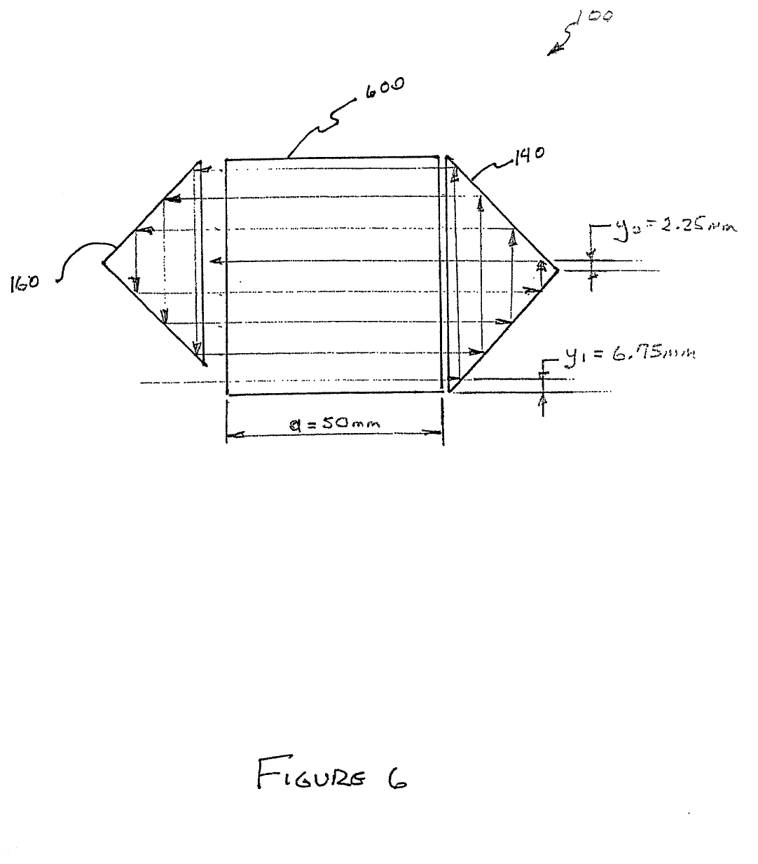

As embodied herein, and depicted in FIG. 6 a cross-sectional view of the switch shown in FIG. 5 is disclosed. The base of prism 140 is equal to the length “a” of beam splitting cube 600; wherein a =50 mm. This is a standard size (50 mm×50mm) for a commercially available beam splitting cube. Prism 160 has a shorter base to accommodate switch inputs. The base of prism 160 is 34.5 mm. The apex of the triangle formed by prism 140 is offset from the signal path by a distance y₀=2.25 mm. The signal input is offset from the bottom of beam splitting cube 600 by a distance y₁=6.75 mm. This number is determined by the size and structure of the LC cell. LC modulators 200 and 300 are identical. The active area of the LC cell is 17 mm×17 mm. Each pixel has a side length of approximately 3.5 mm. In one embodiment the LC cell is a TN LCD. One of ordinary skill in the art will recognize that a ferroelectric LC cell can also be used.

The number of channels that the switch can accommodate is equal to:

$$N = \frac{{a}_{eff}}{4 {y}_{0}} ,$$

where a_{eff} is the dimension of the beam splitting cube. Based on the dimensions shown in FIG. 6, the switch can accommodate 5 channels. One of ordinary skill in the art will recognize that the dimensions used in FIG. 6 can be varied to increase or decrease the number of channels as needed.

There are several ways to make the switches depicted in FIGS. 1-6. In one embodiment, LC modulators 20, 30, 40, 50, 200, and 300 are discrete system components that include two glass substrates with a gap therebetween to hold the liquid crystal material. The cube, prisms, and LC modulators are joined using an adhesive. This approach has several advantages. First, it is simple and very easy to make. Second, it uses standard commercially available LC technology. On the other hand, a reliable adhesive must be used to join the components. Also, use of standard LC technology increases the number of interfaces. Thus, this approach may be lossier. The second approach used to fabricate the present invention uses one glass substrate for the LC device. The LC electrodes are patterned on the substrate. The ground plane of the LC device is patterned onto a facet of the adjacent prism. Thus, the prism facet serves as the second substrate of the LC modulator. After the prism and LC modulator unit is fabricated, it is joined to beam splitting cube 60 or 600 (depending on the switch configuration) using an adhesive. One advantage to this method is that it exhibits less loss because the number of interfaces are reduced. However, it is more difficult to make than the first approach, and the combination of the LC modulator and the prism into a single unit required special tooling. In a third approach, LC material is disposed between facets of the beam splitting cube and the prisms. These facets are used as LC cell substrates. The addressing and ground electrodes are formed on these facets, as well. This approach is the most advantageous from a loss perspective, because it reduces the number of interfaces to a minimum. It also eliminates the need for any adhesives. Unfortunately, this method of fabrication is the most difficult of the three. Again, special tooling is needed to form the LC cells between the facets of the prisms and the beam splitting cube to avoid damaging these components.

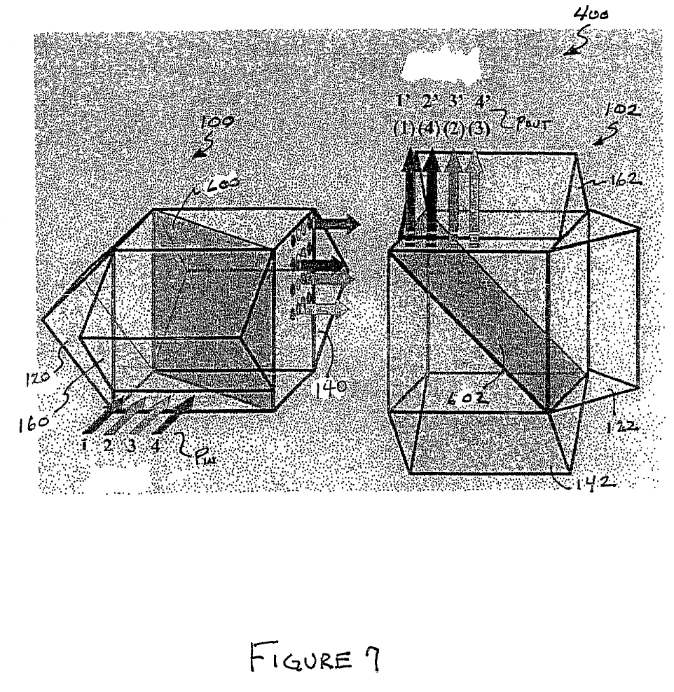

In a third embodiment of the invention, as embodied herein and as shown in FIG. 7 a perspective view of the optical switch according to a third embodiment of the present invention is disclosed. Switch 400 is a 4×4 switch that is fabricated using switch 100 (shown in FIGS. 5 and 6) and switch 102. Switch 102 is the mirror image of switch 100, rotated 90° with respect to switch 100. Switch 102 includes beam splitter 602, which corresponds to beam splitter 600 of switch 100. Switch 102 also includes prisms 122, 142, and 162, which correspond to switch 100 prisms 120, 140, and 160, respectively. These is also a one-to-one correspondence between the LC modulators (not shown) used in switch 100 and switch 102. Using this configuration, any input of switch 100 can be directed to any output of switch 102. The inputs of switch 102 are aligned with the outputs of switch 100.

Collimating light in 4×4 switch 400 is an important aspect of the design. One of ordinary skill in the art will recognize that collimator lenses will be employed between switch 100 and switch 102. Using 50 mm cubes there is approximately a one meter distance between cubes. Thus, care must be taken to avoid collimator misalignment. There are three types of collimator misalignment that can introduce insertion loss: separation misalignment between lens surfaces; offset misalignment of the longitudinal axes of the collimators; and angular tilt misalignment of the longitudinal axes of the collimator lenses. Losses can also occur due to refractive index mismatches. The refractive indices of all components must be matched to avoid reflection losses. Finally, there are losses due to the beam splitting cube. Transmitted p-polarized light has more loss (>1%) than does s-polarized light. However, this loss is mitigated by the rotation of switch 102. The p-polarized light is converted into s-polarized light and losses are low.

It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents.

What is claimed is:

1. An optical device for directing a plurality of light signals, the plurality of light signals being received from a plurality of input ports and cross-connected into a plurality of output ports, the optical device comprising:
a plurality of polarization modulators coupled to the plurality of input ports and the plurality of output ports, wherein each polarization modulator is selectable to modulate one of the plurality light signals between a first polarization state and a second polarization state;
a light routing device coupled to and interposed between the plurality of polarization modulators, the light routing device reflecting light signals in the first polarization state and transmitting light signals in the second polarization state; and
a plurality of prisms coupled to the light routing device, whereby a light signal within the optical device is re-directed to a selected output.

2. The optical device of claim 1, wherein the polarization modulators are comprised of liquid crystal devices.

3. The optical device of claim 2, wherein the liquid crystal devices are nematic liquid crystal devices.

4. The optical device of claim 2, wherein the liquid crystal devices are ferroelectric liquid crystal devices.

5. The optical device of claim 1, wherein the light routing device is a polarization beam splitter having a six facets arranged in a cubic shape.

6. The optical device of claim 5, wherein a first input, first output, a fourth input and a fourth output are disposed on a first facet of the polarization beam splitter, and a second input, second output, a third input and a third output are disposed on a second facet of the polarization beam splitter to form a 4×4 switch.

7. The optical device of claim 6, wherein the plurality of polarization modulators comprise eight liquid crystal modulators.

8. The optical device of claim 7, wherein the eight liquid crystal modulators are disposed on four facets of the polarization beam splitter, whereby two liquid crystal modulators are disposed on each facet.

9. The optical device of claim 7, wherein a first liquid crystal modulator is coincident with the first input, a second liquid crystal modulator is coincident with the second input, a third liquid crystal modulator is coincident with the third input, and a fourth liquid crystal modulator is coincident with the fourth input.

10. The optical device of claim 6, wherein the plurality of prisms comprises a first prism disposed on the third facet of the polarization beam splitter, a second prism disposed on the fourth facet of the polarization beam splitter, and a third prism disposed on the fourth facet of the polarization beam splitter.

11. The optical device of claim 5, wherein the plurality of inputs are disposed as a linear array on a first facet of the polarization beam splitter, and the plurality of prisms comprise a first prism on the first facet, a second prism on a second facet of the polarization beam splitter, and a third prism on a third facet of the polarization beam splitter, the third facet opposing the first facet.

12. The optical device of claim 11, wherein the plurality of outputs are disposed on a fourth facet of the polarization beam splitter, the fourth facet opposing the second facet.

13. The optical device of claim 1, wherein the plurality of output ports include shutters.

14. The optical device of claim 1, wherein a polarizer is disposed between each polarization modulator and prism.

15. A modular free-space optical switch for directing a plurality of light signals, the optical switch comprising:
at least one first optical switch component for cross-connecting the plurality of light signals, the first optical switch component including,
a plurality of first inputs and a plurality of first outputs,
a polarization beam splitter having a cubic shape, and coupled to the plurality of first inputs and the plurality of second outputs, whereby light signals having a first polarization state are reflected and light signals having a second polarization state are transmitted,
a plurality of liquid crystal modulators coupled to the polarization beam splitter, each liquid crystal modulator being selectable to modulate one of the plurality light signals between a first polarization state and a second polarization state, and
a plurality of prisms coupled to the polarization beam splitter and the plurality of liquid crystal modulators, whereby the plurality of light signals propagating within the optical device are re-directed; and
at least one second optical switch component for cross-connecting the plurality of light signals, the second optical switch component being the mirror image of the first optical switch component, rotated 90° with respect the first optical switch component, and having a plurality of second inputs and a plurality of second outputs, whereby the second inputs are aligned and coupled to the first outputs.

16. A method for fabricating an optical cross-connect, the method comprising the steps of:
providing a polarization beam splitting cube;
disposing a plurality of liquid crystal modulators on the polarization beam splitting cube; and
disposing a plurality of prisms on the polarization beam splitting cube.

17. The method of claim 16, wherein the step of disposing a plurality of liquid crystal modulators includes providing liquid crystal modulators having two glass substrates.

18. The method of claim 16, wherein the step of disposing a plurality of liquid crystal modulators includes providing liquid crystal modulators having one glass substrate, such that a facet of the polarization beam splitting cube forms a second glass substrate for the liquid crystal modulator.

19. The method of claim 16, wherein the step of disposing a plurality of liquid crystal modulators includes disposing liquid crystal between facets of the polarization beam splitting cube and the plurality of prisms.

20. The method of claim 16, wherein the beam splitting cube is approximately 50 mm×50 mm.

21. The method of claim 16, wherein an active area of the liquid crystal modulator is approximately 17 mm×17 mm.

22. The method of claim 16, wherein the plurality of prisms comprise a first prism having a first effective length, and a second prism having a second length shorter than the first effective length.

23. The method of claim 22, wherein the first effective length is approximately equal to 50 mm, and the second effective length is approximately equal to 34.5 mm.

24. The method of claim 22, wherein the number of channels N, supported by the optical device is:
$$N = \frac{{a}_{eff}}{4 {y}_{0}} ,$$
wherein a_{eff} is the first effective length and y₀ is the difference of the position of the two prisms in the vertical direction.
